(19) United States
(12) Patent Application Publication
(10) Pub. No.: US 2022/0166103 A1
(43) Pub. Date: May 26, 2022

(54) METAL-ION ACCUMULATOR PROVIDED WITH A DEGASSING DUCT, ASSOCIATED BATTERY MODULE OR BATTERY PACK WITH LIQUID COOLING

(71) Applicant: COMMISSARIAT A L'ENERGIE ATOMIQUE ET AUX ENERGIES ALTERNATIVES, Paris (FR)

(72) Inventors: Fabrice MEE, Grenoble Cedex 09 (FR); Lionel DE PAOLI, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 17/456,183

(22) Filed: Nov. 23, 2021

(30) Foreign Application Priority Data
Nov. 23, 2020 (FR) 20 11982

(51) Int. Cl. H01M 50/342; H01M 50/204; H01M 50/249; H01M 10/613; H01M 10/615; H01M 10/625; H01M 10/6568; H01M 10/0525

(52) U.S. Cl. CPC H01M 50/3425; H01M 50/204; H01M 50/249; H01M 10/613; H01M 2220/20; H01M 10/625; H01M 10/6568; H01M 10/0525; H01M 10/615

(57) ABSTRACT

The invention relates to a metal-ion electrochemical battery or accumulator, comprising:
a housing (6) of longitudinal axis (X),
a rupture zone (60) of a part of the housing, forming a safety vent for the degassing of the accumulator,
at least one duct (10) comprising at least one rigid part (14) forming a stiffener, fixed or formed integrally with the part of the housing, around the safety vent, and a flexible part (15) arranged tightly with the housing or with the stiffener which is itself tight with respect to the housing, in the extension of the stiffener and around the latter, the flexible part being adapted to be deformed elastically on three orthogonal axes (X, Y, Z), so as to compensate for the plays on these axes when it is inserted and held tightly in a through opening (12) of a casing (11) of a module or battery pack.

### TECHNICAL FIELD

The present invention relates to the field of the metal-ion, in particular lithium-ion, electrochemical generators which operate according to the principle of insertion or of deinsertion, or, in other words, intercalation-deintercalation, of metal ions in at least one electrode.

The present invention aims primarily to improve the collection, notably in terms of safety, of the degassing flows generated in the course of abnormal/accidental operation, typically in cases of thermal runaway, of a metal-ion accumulator, and to do so more particularly when the accumulator is incorporated in a module or a battery pack with an environment that is constrained, notably because of liquid cooling.

Although described with reference to a lithium-ion accumulator, the invention applies to any metal-ion electrochemical accumulator, that is to say also sodium-ion, magnesium-ion, aluminum-ion, etc.

The invention applies equally to prismatic and cylindrical accumulator geometries, and generally to any possible metal-ion accumulator geometry.

### PRIOR ART

As illustrated schematically in FIGS. 1 and 2, a lithium-ion battery or accumulator normally comprises at least one electrochemical cell C composed of an electrolyte component 1 between a positive electrode or cathode 2 and a negative electrode or anode 3, a current manifold 4 connected to the cathode 2, a current manifold 5 connected to the anode 3, and finally, a package 6 arranged to contain the electrochemical cell with seal-tightness while being passed through by a part of the current manifolds 4, 5.

Several types of accumulator architecture geometry are known:
a cylindrical geometry as disclosed in the patent application US 2006/0121348;
a prismatic geometry as disclosed in the patents U.S. Pat. Nos. 7,348,098, 7,338,733;
a stacked geometry as disclosed in the patent applications US 2008/060189, US 2008/0057392 and the patent U.S. Pat. No. 7,335,448.

The electrolyte component 1 can be of solid, liquid or gel form. Under this last form, the component can comprise a separator made of polymer, of ceramic or of microporous composite soaked with organic electrolyte(s) or of ion liquid type which allows the displacement of the lithium ion from the cathode to the anode for a charge and, in reverse, for a discharge, which generates the current. The electrolyte is generally a mixture of organic solvents, for example carbonates in which a lithium salt is added, typically LiPF6.

The positive electrode or cathode 2 is composed of lithium cation insertion materials which are generally composite, such as LiFePO₄, LiCoO₂, LiNi_{0.33}Mn_{0.33}Co_{0.33}O₂.

The negative electrode or anode 3 is very often composed of graphite carbon or of Li₄TiO₅O₁₂ (titanate material), possibly also based on silicon or on a composite formed based on silicon.

The current manifold 4 connected to the positive electrode is generally made of aluminum.

The current manifold 5 connected to the negative electrode is generally made of copper, of nickel-plated copper or of aluminum.

A lithium-ion battery or accumulator can obviously comprise a plurality of electrochemical cells which are stacked one on top of the other.

Traditionally, a Li-ion battery or accumulator uses a pair of materials on the anode and on the cathode that allow it to operate at a high voltage level, typically equal to 3.6 volts.

According to the type of application targeted, the aim is to produce either a lithium-ion accumulator that is thin and flexible or a rigid accumulator: the package is then either flexible or rigid and in the latter case constitutes a kind of housing.

The flexible packages are usually manufactured from a multilayer composite material, composed of a stacking of layers of aluminum covered by one or more films of polymer laminated by bonding.

The rigid packages are, for their part, used when the targeted applications are restricted where a long life is sought, with, for example, much higher pressures to be supported and a stricter required level of seal-tightness, typically less than 10⁻⁸ mbar.l/s, or in environments with strong constraints such as the aeronautical or space domain.

Also, hitherto, a rigid packaging used is composed of a metallic housing, generally made of metal, typically stainless steel (316L or 304 stainless steel) or of aluminum (Al 1050 or Al 3003), or even of titanium. Furthermore, aluminum is generally preferred for its high thermal conductivity coefficient as explained hereinbelow.

The geometry of most of the rigid Li-ion accumulator packing housings is cylindrical, because most of the electrochemical cells of the accumulators are wound by winding on a cylindrical geometry around a cylindrical mandrel. Prismatic forms of housings have also already been produced by winding around a prismatic mandrel.

One of the types of rigid housing of cylindrical form, usually manufactured for a high-capacity Li-ion accumulator, is illustrated in FIG. 3.

A rigid housing of prismatic form is also shown in FIG. 4.

The housing 6 comprises a cylindrical lateral envelope 7, a bottom 8 at one end, a cover 9 at the other end, the bottom 8 and the cover 9 being assembled with the envelope 7. The cover 9 supports the poles or current output terminals 4, 5. One of the output terminals (poles), for example the positive terminal 4, is welded onto the cover 9 whereas the other output terminal, for example the negative terminal 5, passes through the cover 9 with the interposition of a seal that is not represented which electrically insulates the negative terminal 5 from the cover.

The type of rigid housing widely manufactured consists also of a stamp and a cover laser-welded together on their periphery. On the other hand, the current manifolds comprise a bushing with a part protruding on top of the housing and which forms a terminal, also called visible pole of the battery.

One known problem in the Li-ion accumulators is that of the generation of gases sometimes in the electrical formation step and during the operation of the accumulators.

Thus, there are already various devices for releasing the gases generated, in particular in cases of abnormal operation, inside the electrochemical accumulators, in cases of overpressure, devices also called degassing devices.

One device, widely used in particular for the Li-ion accumulators of cylindrical format, notably format 18650, consists in a weakening by precut line, also called rupture line of a part of the housing, more particularly of the cover. This rupture line generally forms a disk which is dimensioned to be pierced beyond a predetermined pressure, which makes it possible to allow the gases to escape out of the accumulator. Such a device with rupture disk forms a safety vent (for “venting”), that makes it possible to drop the internal pressure to a pressure equilibrium with the pressure of the ambient environment.

A battery pack P consists of a variable number of accumulators that can run up to several thousands which are linked electrically in series or in parallel to one another and generally by connecting bars, normally called busbars.

One example of battery pack P is shown in FIG. 5. This pack consists of two modules M1, M2 of Li-ion accumulators A that are identical and linked to one another in series, each module M1, M2 consisting of four rows of accumulators linked in parallel, each row consisting of a number equal to six Li-ion accumulators.

As represented, the mechanical and electrical connection between two Li-ion accumulators of a same row is produced by screwing busbars B1, advantageously made of copper, each linking a positive terminal 4 to a negative terminal 5. The connection between two rows of accumulators in parallel within one and the same module M1 or M2 is ensured by a busbar B2, also advantageously made of copper. The connection between the two modules M1, M2 is ensured by a busbar B3, also advantageously made of copper.

In the development and the manufacturing of lithium-ion batteries, for each charge/discharge profile specific to each new request, whatever the market actors, this requires precise dimensionings (series/parallel electrical, mechanical, thermal and other architectures) to optimally design a powerful and safe battery pack.

A lithium electrochemical system, either on the cell, module or pack scale, produces exothermic reactions regardless of the cycling profile given. Thus, on the unitary accumulator scale, as a function of the chemistries considered, the optimal operation of the lithium-ion accumulators is limited within a certain temperature range.

An accumulator must control its temperature, typically generally below 70° C. on its outer housing surface, in order to avoid the initiation of thermal runaway which can be followed by a generation of gases and explosion and/or fire.

Also, maintaining a temperature lower than 70° C. makes it possible to increase the life thereof, because the more the operating temperature of an accumulator rises, the more its life is reduced.

Furthermore, some accumulator chemistries require an operating temperature well above ambient temperature and, consequently, it proves necessary to regulate their temperature level by initial preheating of the accumulators, even by permanently maintaining the accumulators at a temperature.

In a battery, or battery pack with several Li-ion accumulators, series or parallel connection of more or less different accumulators may have consequences on the resulting performance levels and durability for the pack.

It is thus recognized that, in a battery pack, for example of an electric vehicle, the dispersions of agings can be high based for example on the position of the accumulators, as a result of aging dissymmetries between the accumulators or usage differences (thermal variations between the core and the edges of the pack, current gradient, etc.). Thus, state of health SOH deviations of the order of 20% between accumulators of one and the same pack can be observed.

So, in order to limit the premature aging of the pack, it is necessary to optimize the operating temperature and the dispersion of temperature from one accumulator to another. An accumulator (or multiple accumulators) which ages (age) faster than the others can have a direct impact on the electric performance levels of the complete battery pack.

On the module and pack scale, typically below 0° C. for example, it may be necessary to have use of a particular drive control system via a BMS, in order to limit the power demanded of the pack and avoid degradation of the accumulators.

It is recalled here that the BMS (acronym for “Battery Management System”) is used in order to track the state of the various accumulators (state of charge, state of health, etc.) and to drive the various safety elements, such as currents that must not become too high, unsuitable potentials (too high or too low), limit temperatures, and its function is therefore notably to stop the current applications as soon as threshold voltage values are reached, i.e. a potential difference between the two active insertion materials. The BMS therefore stops the current applications (charge, discharge) as soon as the threshold voltages are reached.

Beyond a higher temperature, typically of the order of 70° C., vigilance is also necessary because electrochemical reactions can lead to the destruction of the unitary accumulators and provoke a propagation of a fault internal to the accumulator, typically an internal short-circuit, which, in the extreme case, can cause the pack to explode. In this case, it is also necessary to have use of the BMS, in order to protect the accumulators.

Consequently, a battery pack generally requires a highly efficient BMS, in order to generate voltage equalizations.

On the other hand, it is well understood that a thermally balanced battery pack is also a necessity.

The difficulty arises in ensuring the uniformity of the temperature within a battery pack.

One known solution for trying to ensure temperature uniformity within a battery pack consists in having a heat-transfer fluid (gaseous or liquid) circulate within a battery pack.

A coolant can be used instead of air. However, the notions of cost, bulk and additional weight can be prevailing factors based on the application considered.

For example, air cooling is the least costly solution since, as indicated, it consists of forced air ventilation between the accumulators. On the other hand, the thermal performance levels of air cooling are of low quality because of the fairly low exchange coefficient and its low thermal inertia. Thus, in this type of cooling, the first accumulator will be heated up despite everything on contact with the air and the air temperature will increase. On passing on to the second accumulator, the air is hotter and the accumulator is hotter than the first. Finally, accumulators with non-uniform temperature are therefore obtained.

The solutions by liquid cooling are significantly more efficient.

Control of the random degassing flows from the accumulators, as discussed above, in particular in an accidental thermal runaway context, poses safety problems in all the battery packs. The total volume of these volume degassing flows can rise to several dozen liters.

That is all the more true when a liquid cooling system is implemented. In fact, both gas circuits and a liquid circuit have to be managed.

The patent application DE102011087198 A1 discloses a battery pack with a gas collection system common to several battery modules each incorporating several accumulators, the common collection circuit comprising a single storage zone for the gases in which an absorbent material of activated carbon type is arranged. The system disclosed does not make it possible to prevent the propagation of a gas-generating fault to the neighboring accumulators.

The patent application DE102013201365 A1 also discloses a battery pack with a common gas collection system in which each accumulator is partitioned temporarily by walls forming flaps that can be opened under pressure in order to channel the gases into one and the same manifold, then discharge them outward through vents opening into the manifold.

The patent application JP2010215019 discloses a battery module with a plurality of accumulators 1of prismatic geometry comprising a holding part in which the accumulators are arranged and held parallel to one another. An elastic jacket made of rubber is arranged around each accumulator vent, between a discharge duct for the gases likely to be discharged from the accumulators, and the top face of the housing of the accumulators. A metal insert embedded in the elastic jacket allows the latter to be pressed against the faces of the accumulators. In the configuration disclosed in this patent application, the gases discharged from a given accumulator necessarily come into contact with the other accumulators and their vents and all the escapes of gas from the accumulators are pooled in a confined common space.

None of the systems according to the abovementioned patent applications propose an individual solution, that is to say accumulator by accumulator, to the degassing problem. They do not therefore take account of the mechanical compensations necessary to the correct aging of an accumulator during its life cycle (charges and discharges), which drives the inflation of the accumulator and imposes strong integration constraints.

Furthermore, the systems proposed are unusable in the context of a module or battery pack which has to be compact (low volume/energy density ratio) and/or when an active cooling system is implemented, with the coolant in direct contact with the accumulators.

There is therefore a need to further improve the solutions for collection of the degassing flows from a metal-ion accumulator, incorporated in a module or battery pack, notably when liquid cooling is implemented.

The general aim of the invention is then to at least partly address this need.

### SUMMARY OF THE INVENTION

To do this, the subject of the invention is, first of all, a metal-ion electrochemical battery or accumulator, comprising:
a housing of longitudinal axis (X),
a rupture zone for a part of the housing, forming a safety vent for the degassing of the accumulator,
at least one duct comprising at least one rigid part forming a stiffener, fixed tightly to or formed integrally with the part of the housing, around the safety vent, and a flexible part arranged tightly with the housing or with the stiffener which is itself tight with respect to the housing, in the extension of the stiffener and around the latter, the flexible part being adapted to be deformed elastically on three orthogonal axes (X, Y, Z) so as to compensate the plays on these axes when it is inserted and held tightly in a through opening of a module or battery pack casing.

Thus, the invention relates essentially to providing each metal-ion accumulator of prismatic geometry, intended to be incorporated in a module or battery pack, with a duct in the continuity of the safety vent, in order to safely discharge the degassing flows from said accumulator out of the module or of the battery pack.

The solution according to the invention is all the more advantageous when the module or battery pack is in a constrained environment, particularly when liquid cooling is implemented.

The duct comprises two parts, namely a stiffener directly around the safety vent and a flexible part in the extension of the stiffener.

The stiffener makes it possible on the one hand to guarantee a gas passage section at the vent output that is always of constant value corresponding to the section defined by the rupture zone, which can be a simple rupture line, of the vent is, for its part, incorporated in the base of the bellows and, on the other hand, ensure the integrity of the flexible part under the possible constraints external to the accumulator, of pressurizing or crushing type, for example generated by the cooling by complete immersion in the heat-transfer liquid.

The material of the stiffener can be chosen to be compatible with the nature, temperature, pressure of the gases likely to be discharged through the safety vent.

The flexible part of the duct is capable of compensating plays on 3 axes (X, Y and Z). They can be mechanical plays resulting from the charge and discharge cycles of the accumulators which cause the latter to inflate: the compensations are then dynamic. They can also be assembly plays: the compensations are, in this case, static. Generally, the plays can be those linked to the assembly of each accumulator with the casing of a module or battery pack, or minor movements of the accumulators linked to their geometric variations during their life, such as volume variations in cycling.

The flexible part is more in contact/compatible with the environment in the casing of the module or the battery pack, for example the coolant.

The incorporation of a combined duct (stiffener/flexible part) in each accumulator within a module or battery pack makes it possible to compensate the various plays between the accumulators throughout their life cycles, without creating additional mechanical stresses.

A duct according to the invention can be able to be envisaged with any form corresponding to that of a safety vent, notably with cylindrical or elliptical section. Likewise, the geometry of accumulators for which the invention can be implemented can be prismatic, cylindrical or according to any other form, provided that it has a degassing vent which can be separated from the coolant by a duct in accordance with the invention, and do so without hampering the connection systems of the accumulator or other surrounding components.

Regarding the mounting and the fixing of the duct according to the invention, it is for example possible to envisage by a method for bonding the stiffener and, if appropriate, the flexible part to the accumulator housing and various possible solutions for the flexible part to the module or battery pack casing, for example a plugging, cladding or other such method.

To date, the incorporation of metal-ion accumulators in a module or battery pack is problematical.

In fact, a given accumulator is a mechanical component likely to have strong dimensional variations linked on the one hand to the manufacturing methods and on the other hand to its life cycle. These strong variations make it difficult to incorporate in a functional chain of cords.

If, to this, all the assembly plays are added, it becomes very difficult to precisely guarantee the positioning of all of the safety vents of the accumulators within an overall system that a module or battery pack constitutes.

The invention makes it possible to overcome the strong variations and assembly plays. To do this, the invention individually secures the degassing of each accumulator with a tight duct at the safety vent output, capable of supporting mechanical plays over several millimeters on each axis, while keeping its integrity.

In the context of the invention, the projection of the gases out of the duct into a space outside of the module or battery pack casing is a projection into a space/volume that is preferentially significant compared to the space inside the casing. In other words, a gas flow discharged from a given accumulator is typically placed in contact with the atmosphere outside of the module or battery pack, and therefore with a strong effect of expansion and of non-confinement and therefore of cooling of the flow through these two effects. To put it yet another way, there is no confinement of the hot/polluted/pressurized flow to the contact of the other accumulators or even of the vents of the other accumulators, as in the state of the art, notably in the patent application JP2010215019.

As already indicated, in a battery module or battery pack, each accumulator individually has a duct/pipe which allows this discharging out of the casing of the module or pack, without being pooled in a confined common space. That is advantageous because a confined space can induce a risk of negative feedback of the released gases to the other accumulators of the module or pack. The safety of the module or battery pack casing is therefore ensured at the level of each accumulator, and not pooled at the level of a common duct as in the state of the art, notably in JP2010215019. The safety is therefore increased in the event of thermal runaway.

Ultimately, the advantages of the solution according to the invention over the solutions according to the state of the art cited in the preamble are many and ones that can be cited include:
an individual treatment of the degassing potentials of the accumulators, which improves the safety of a module or battery pack;
the absence of mechanical stresses of a module or battery pack which would be linked to the potential degassing flows from the accumulators;
a compensation and a not-inconsiderable flexibility of the assembly plays of a module or battery pack.

According to a first advantageous embodiment, the stiffener is a part directly fixed onto the part of the housing, the flexible part being also a part directly fixed onto the part of the housing and distinct from the stiffener.

According to this first embodiment, the top portion of the stiffener comprises at least two lugs that are diametrically opposite in a radial direction of the duct and protrude outward therefrom.

Several overmolding manufacturing methods can be envisaged to simplify the mounting and the incorporation of the duct on an accumulator. A manufacture with overmolding can also make it possible to lower the costs over large production volumes.

Thus, according to a first advantageous embodiment, the stiffener and the flexible part constitute a single one-piece part.

According to a variant of the first embodiment, the stiffener is a part directly fixed onto the part of the housing, the flexible part being overmolded on the stiffener.

According to another variant of the first embodiment, the flexible part is a part directly fixed onto the part of the housing, the stiffener comprising at least one ring overmolded inside the flexible part.

According to a second advantageous embodiment, the stiffener is a part distinct from a part forming the flexible part.

According to a first variant of this second embodiment, the part forming the stiffener is a part directly fixed onto the part of the housing, the part forming the flexible part being also directly fixed onto the part of the housing.

According to a first variant of this second embodiment, the stiffener is a part directly fixed onto the part of the housing, the flexible part being an elastic ring force-fitted on the stiffener. The fitted ring can be of existing silentbloc type which provides the play compensator function. With the degassing of an accumulator creating a strong temperature rise, this embodiment has the advantage of offering a greater choice in the duct materials and manufacturing methods. Furthermore, the assembly and the bonding thereof on the accumulator housing would be facilitated, through its mechanical strength.

According to an advantageous feature, the top portion of the stiffener comprises at least two lugs that are diametrically opposite in a radial direction of the duct and protrude outward therefrom. According to an advantageous variant embodiment, the flexible part is a bellows comprising:
a fixing portion forming a base,
a central portion in the extension of the base, comprising at least one fold suitable for being elastically deformed on the three orthogonal axes (X, Y, Z),
a blocking portion in the extension of the central portion, the blocking portion being adapted to be inserted and held in the through opening.

Advantageously, the stiffener is made of a high-temperature plastic, chosen from among polyetheretherketone (PEEK) or polyetherimide (PEI), or made of aluminum or of ceramic.

Also advantageously, the flexible part is made of elastomer chosen from among a rubber, a nitrile or a silicone.

According to an advantageous variant embodiment, the flexible part comprises, at its free end, a precut tapered end-fitting, adapted to perform the centering and the positioning of the flexible part in the through opening.

Another subject of the invention is a module or battery pack, comprising:
a plurality of metal-ion electrochemical batteries or accumulators such as those described previously,
a heat-transfer fluid circuit for cooling or heating up the accumulators, comprising a tank of heat-transfer fluid in which the accumulators are immersed, the tank comprising a casing pierced by a plurality of through openings into each of which the flexible part of an accumulator duct is inserted and held tightly.

The module or battery pack advantageously comprises, as member for tightly holding the flexible part of the duct of each accumulator, a fixing flange force-fitted into the flexible part inserted into a through opening.

According to an advantageous embodiment, the module or battery pack is configured such that each accumulator duct can discharge the gases likely to be released through its vent, into a space outside of the casing of the module or battery pack, notably to the atmosphere. It is specified here that the casing is the general jacket of the module or battery pack in which the set of accumulators is fixed and held.

Other advantages and features will emerge more clearly on reading the detailed description, given in an illustrative and nonlimiting manner, with reference to the following figures.

### BRIEF DESCRIPTION OF THE DRAWINGS

FIG. 1 is an exploded perspective schematic view showing the various elements of a lithium-ion accumulator.

FIG. 2 is a front view showing a lithium-ion accumulator with its flexible packaging according to the state of the art.

FIG. 3 is a perspective view of a lithium-ion accumulator according to the state of the art with its rigid packaging consisting of a housing of cylindrical form.

FIG. 4 is a perspective view of a lithium-ion accumulator according to the state of the art with its rigid packaging consisting of a housing of prismatic form.

FIG. 5 is a perspective view of an assembly, by means of busbars, of lithium-ion accumulators of cylindrical geometry according to the state of the art, forming a battery pack.

FIG. 6 is a perspective view of an example of mounting of a lithium-ion accumulator of prismatic geometry according to the invention in a battery pack casing.

FIG. 7 is a partial longitudinal cross-sectional view of FIG. 6, showing in detail the accumulator provided with its duct according to the invention.

FIG. 8 is a top view of a lithium-ion accumulator of prismatic geometry according to the invention, showing the safety vent.

FIG. 9 is a perspective view of a first embodiment of a duct as fixed to an accumulator according to the invention.

FIG. 10 is a perspective view of the flexible part of the duct according to FIG. 9.

FIG. 11 is a perspective view of the rigid part of the duct according to FIG. 9.

FIG. 12 is a perspective view of a second embodiment of a duct according to the invention.

FIG. 13 is a perspective view of a third embodiment of a duct according to the invention.

FIG. 14 is a perspective view of a fourth embodiment of a duct according to the invention.

FIG. 15 refers back to FIG. 9, showing by transparency the rigid part surrounded by the flexible part of the duct according to the invention.

FIG. 16 is a perspective view of a variant of the duct according to FIG. 15.

FIG. 17 is a perspective view of a variant of the flexible part of a duct according to the invention, according to which a precut tapered end-fitting is arranged.

FIG. 18 is a perspective view of a battery pack with the placement in the casing for each of the accumulators by means of a tapered end-fitting according to FIG. 17.

### DETAILED DESCRIPTION

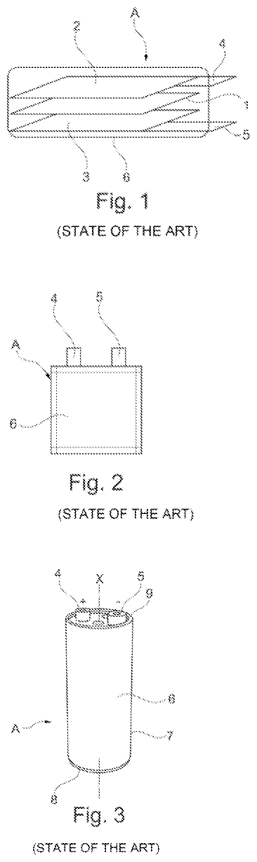

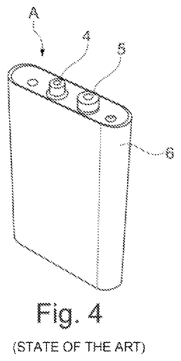

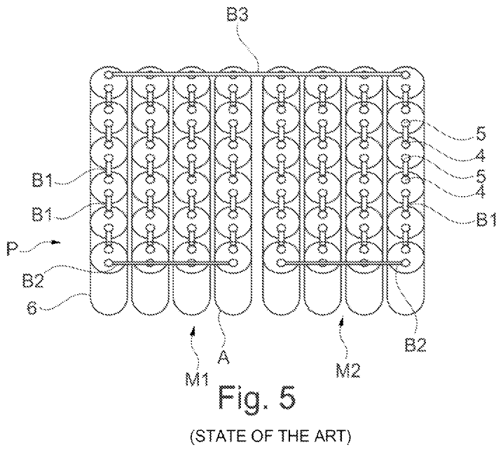

FIGS. 1 to 5 relate to different examples of a Li-ion accumulator, with flexible packagings and accumulator housings and a battery pack according to the state of the art. These FIGS. 1 to 5 have already been commented on in the preamble and are not therefore discussed more hereinbelow.

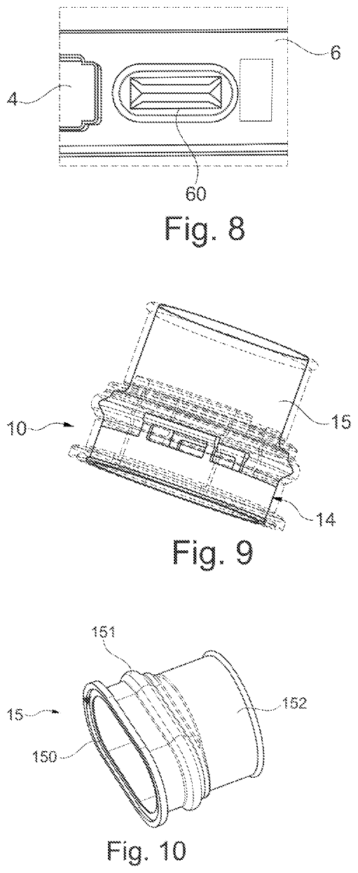

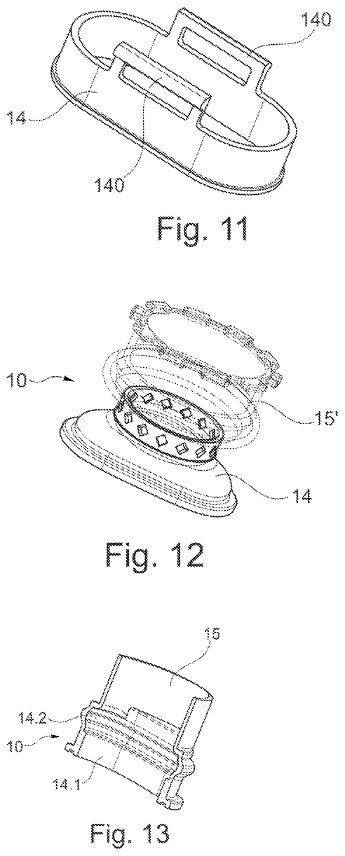

For clarity, the same references designating the same elements according to the state of the art and according to the invention are used for all the FIGS. 1 to 18.

Throughout the present application, the terms “low”, “high”, “below”, “above”, “bottom” and “top” should be understood with reference to the arrangement of a metal-ion accumulator according to the invention vertically in a battery pack.

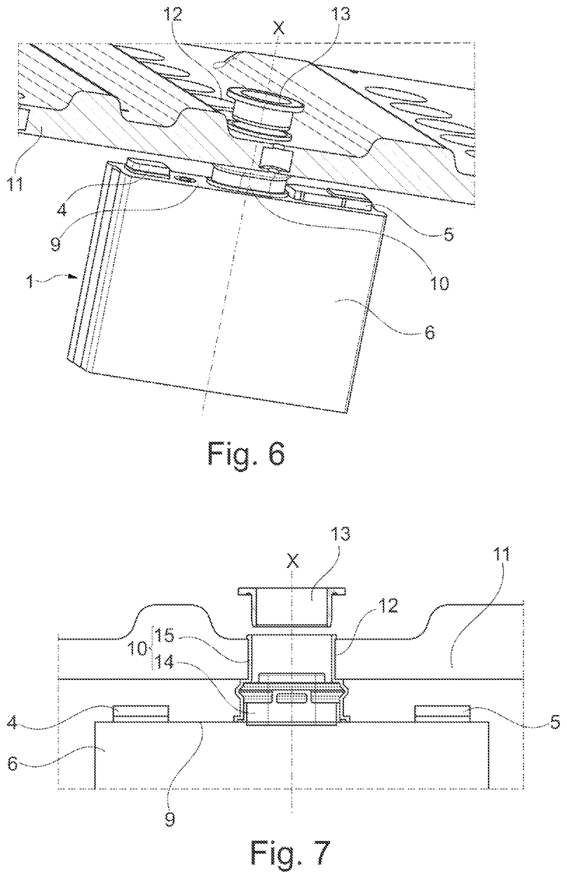

FIGS. 6 and 7 illustrate a Li-ion accumulator of prismatic geometry of longitudinal axis X with a duct 10 according to the invention, and as it is inserted into a battery pack casing 11.

The casing 11 is that of a tank of heat-transfer liquid in which the Li-ion accumulators according to the invention are at least partially immersed.

As illustrated, the duct 10 is inserted into a through opening 12 and is held with the accumulator in the latter by means of a fixing flange 13 according to a plugging method.

More specifically, the duct 10 comprises a rigid part forming a stiffener 14, fixed tightly to the cover 9 of the accumulator housing 6, around the safety vent 60. The section of the stiffener 14 corresponds to that of the vent 60, which makes it possible to comply with and secure the section of passage of the gas flows defined by the manufacturer of the accumulator.

The stiffener 14 can be made of high-temperature technical plastic of PEEK or PEI type. It can be bonded directly to the cover 9 of the housing around the safety vent 60.

The duct 10 also comprises a flexible part 15 arranged tightly in the extension of the stiffener 14 and around the latter.

As illustrated in FIGS. 6 and 7, one end of the flexible part 15 is fixed directly onto the cover 9 of the housing 6 and/or onto the stiffener 14, while the other end is inserted into the through opening 12 and held therein by the fixing flange 13 which is force-fitted therein.

The integrity of the flexible part 15 subjected to the mechanical stresses of pressure or crushing types, notably by the heat-transfer liquid in the tank, is ensured by the stiffener 14.

The flexible part 15 can be made of elastomer, such as a rubber, a nitrile, a silicone.

According to the invention, the flexible part 15 adapted to be deformed elastically on three orthogonal axes (X, Y, Z), so as to compensate for the plays on these axes. The plays can be those linked to the assembly of each accumulator in the casing of a module or battery pack, or minor movements of the accumulators linked to their geometrical variations during their lifetime, such as volume variations in cycling.

As an example, the flexible part 15 can be dimensioned with a possible deformation of +/−1.5 mm on the axes X-Y and 0 to 2 mm on the axis Z.

The duct 10 as such and its two parts 14, 15 of which it is formed are represented in FIGS. 9 to 11.

The stiffener 14 comprises, in its top part, two lugs 140 that are diametrically opposite in a radial direction of the duct and that protrude outward therefrom. The function of these lugs 140 is to limit the deformation (crushing) of the flexible part 15 under the various possible stresses linked to the environment, more particularly to the liquid cooling of the battery pack, inside the casing.

The part 15 forming the flexible part is a bellows comprising three adjacent portions 150, 151, 152.

The annular portion 150 forming the base of the bellows serves as plane of bonding to the cover 9 of the housing 6 or to the stiffener 14. The bonding is done by deposition of a bead of glue on the cover 9 and the annular portion 150 is pressed against this bead of glue.

The central portion 151 in the extension of the base 150 comprises a gauged fold whose function is to compensate for the plays on the 3 axes X, Y, Z.

The top portion 152 in the extension of the central portion 151 allows the insertion and the blocking of the bellows 14 in a through opening 12 of the casing 11.

Various other embodiments of the degassing duct 10 based on overmolding can be envisaged in order to simplify the mounting and the incorporation of the duct and also lower the production costs for significant volumes.

FIG. 12 shows a flexible part 15′ directly overmolded on the stiffener 14. In this FIG. 12, the visible holes, produced on the top periphery of the stiffener 14, serve as a die for the attachment of the flexible material of the overmolded part 15′.

FIG. 13 illustrates an overmolding of two rigid rings 14.1, 14.2 forming the stiffener 14 directly inside the bellows 15.

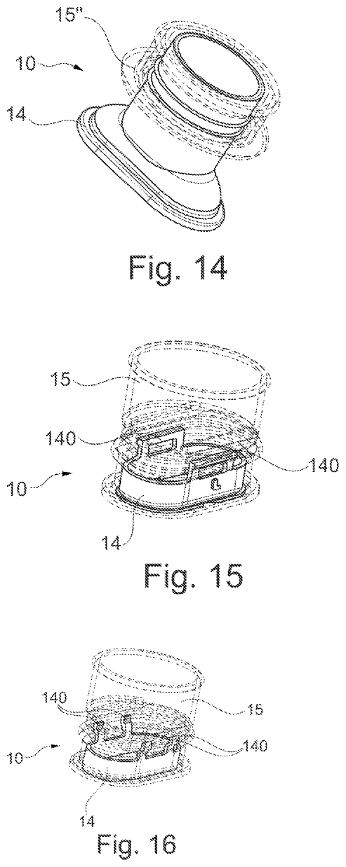

FIG. 14 illustrates an embodiment whereby the stiffener 14 extends over the entire height, i.e. from the cover 9 of the housing 6 to the top part of the through opening, an elastic ring 15″ of silentbloc type forming the flexible part being force-fitted around the top part of the stiffener 14.

In the embodiment in which the bellows 15 completely surrounds the stiffener 14, two rectilinear lugs 140 can be provided in the form of small bars, that are diametrically opposite (FIG. 15), or a greater number of spot lugs 140 (FIG. 16).

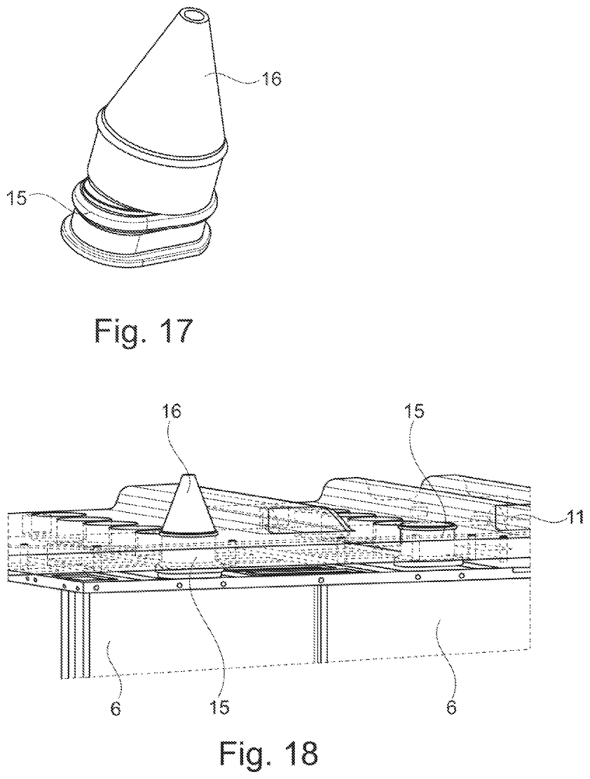

As shown in FIGS. 17 and 18, in order to facilitate the placement of the bellows 15 upon the closure of the casing 11 of the battery pack, it is possible to implement a precut tapered end-fitting 16 at the top end of the bellows 15. This tapered end-fitting 6 allows the centering and the positioning of the bellows 15 through a through opening 12 of the casing 11.

Once the positioning has been done, the tapered end-fitting 16 is cut easily, in order to allow the duct 10 to emerge on the outside of the casing 11 and allow the final fixing, notably by means of a fixing flange 13 in a plugging method.

At the end of this method, with the duct 10 emerging on the outside, the safety vent is in contact with the outside atmosphere.

The invention is not limited to the examples which have just been described; notably, features of the examples illustrated can be combined with one another in variants that are not illustrated.

Other variants and enhancements can be envisaged without in any way departing from the scope of the invention.

While, in the example illustrated, the safety vent has an elliptical section, it is possible to envisage any other vent section and consequently duct section, notably a cylindrical section.

Also, while the duct according to the invention around the safety vent can consist, as previously described, of two different parts, it can perfectly well be produced as a single part, preferably made of a single material, fixed directly and tightly to the housing. In the case of a single part, the choice of the material and its dimensioning should be made to guarantee both the integrity of the duct as such with respect to the degassing and the coolant and sufficiently flexible to compensate for the plays. Typically, the material can be a grade of rubber with a local thickening to locally provide greater rigidity.

1. A metal-ion electrochemical battery or accumulator, comprising:
a housing of longitudinal axis,
a rupture zone of a part of the housing, forming a safety vent for the degassing of the accumulator,
at least one duct comprising at least one rigid part forming a stiffener, fixed or formed integrally with the part of the housing, around the safety vent, and a flexible part arranged tightly with the housing or with the stiffener that is itself tight with respect to the housing, in the extension of the stiffener and around the latter, the flexible part being adapted to be deformed elastically on three orthogonal axes, so as to compensate for the plays on these axes when it is inserted and held tightly in a through opening of a casing of a module or battery pack.

2. The metal-ion electrochemical battery or accumulator according to claim 1, wherein the stiffener and the flexible part constitutes a single one-piece part.

3. The metal-ion electrochemical battery or accumulator according to claim 2, wherein the stiffener is a part directly fixed onto the part of the housing, the flexible part being overmolded on the stiffener.

4. The metal-ion electrochemical battery or accumulator according to claim 2, wherein the flexible part is a part directly fixed onto the part of the housing, the stiffener comprising at least one ring overmolded inside the flexible part.

5. The metal-ion electrochemical battery or accumulator according to claim 1, wherein the stiffener is a part distinct from a part forming the flexible part.

6. The metal-ion electrochemical battery or accumulator according to claim 5, wherein the part forming the stiffener is directly fixed onto the part of the housing, the part forming the flexible part being also directly fixed onto the part of the housing.

7. The metal-ion electrochemical battery or accumulator according to claim 5, wherein the stiffener is a part directly fixed onto the part of the housing, the flexible part being an elastic ring force-fitted onto the stiffener.

8. The metal-ion electrochemical battery or accumulator according to claim 5, wherein the top portion of the stiffener comprise at least two lugs that are diametrically opposite in a radial direction of the duct and that protrude outward therefrom.

9. The metal-ion electrochemical battery or accumulator according to claim 1, wherein the flexible part is a bellows comprising:
a fixing portion forming a base,
a central portion in the extension of the base, comprising at least one fold adapted to be deformed elastically on the three orthogonal axes,
a blocking portion in the extension of the central portion, the blocking portion being adapted to be inserted and held in the through opening.

10. The metal-ion electrochemical battery or accumulator according to claim 1, wherein the stiffener is made of a high-temperature plastic, chosen from among polyetheretherketone (PEEK) or polyetherimide (PEI), or made of aluminum, or of ceramic.

11. The metal-ion electrochemical battery or accumulator according to claim 1, wherein the flexible part is made of elastomer chosen from among a rubber, a nitrile or a silicone.

12. The metal-ion electrochemical battery or accumulator according to claim 1, wherein the flexible part comprises, at its free end, a precut tapered end-fitting, adapted to produce the centering and the positioning of the flexible part in the through opening.

13. A module or battery pack, comprising:
a plurality of metal-ion electrochemical batteries or accumulators according to claim 1,
a heat-transfer fluid circuit for cooling or heating up the accumulators, comprising a tank of heat-transfer fluid in which the accumulators are immersed, the tank comprising a casing drilled with a plurality of through openings in each of which the flexible part of an accumulator duct is inserted and held tightly.

14. The module or battery pack according to claim 13, comprising, as member for tightly holding the flexible part of the duct of each accumulator, a fixing flange force-fitted in the flexible part inserted into a through opening.

15. The module or battery pack according to claim 13, configured so that each accumulator duct can discharge the gases likely to be given off through its vent, in a space outside of the casing of the module or battery pack.
